(19) United States
(12) Patent Application Publication
(10) Pub. No.: US 2019/0108405 A1
(43) Pub. Date: Apr. 11, 2019

(54) GLOBALLY OPTIMIZED RECOGNITION SYSTEM AND SERVICE DESIGN, FROM SENSING TO RECOGNITION

(71) Applicant: Weixin Xu, Santa Clara, CA (US)

(72) Inventor: Weixin Xu, Santa Clara, CA (US)

(21) Appl. No.: 15/729,612

(22) Filed: Oct. 10, 2017

(51) Int. Cl. G06K 9/00; G06K 9/62; G08B 13/196; G08B 27/00; G06F 17/30

(52) U.S. Cl. CPC G06K 9/00771; G06K 9/00255; G06K 9/6256; G06F 17/30256; G06K 9/6202; G08B 13/19684; G08B 27/003; G06K 9/00288

(57) ABSTRACT

Systems and methods are disclosed for improved security monitoring. The system includes cameras mounted to consistently capture facial images. The images are then recognized by a learning machine optimized for the consistently captured images. All cameras form a large scale security network whose sensors generate security information (such as strangers, threatening personal); human authenticates security information and benefits from such information. The large scale security network is able to predict imminent threats with high precision and in real time. The network's intelligence grows as usage grows, or as new nodes joins the network.

The present invention relates to face recognition cameras systems, services and peripherals.

### BACKGROUND

Traditional surveillance aims to provide high recognition accuracy but often does not meet expectations for various reasons, such as lighting, installation, machine learning and deep learning model accuracies, training and inferencing data distribution and bias. Traditional surveillance system is also single point based, with little or no temporal and spatial information association, and little or no threat prediction.

One issue is the camera design and installation. Typically security cameras are installed at a high point such as above the door. Such high positioning is good for area coverage and occlusion mitigation, but is not ideal for face recognition. Conventional camera systems are also difficult to install for regular consumers due to necessary drilling into wood door frame/wall for mounting.

Another issue is training and inferencing data distribution caused low accuracy. Typically the models are trained using internet images or proprietary images. Such images usually have different distribution such as exposure, motion blur and angle, compared to images captured by deployed cameras at different height and angle. Due to above mentioned issues, face recognition in uncontrolled environment has low accuracy.

Another issue is no identity temporal recognition in uncontrolled environment. Due to above mentioned low recognition accuracy in uncontrolled environment, the backend doesn't recognize and alert a person's identity times after the first time.

Another issue is the lack of identity spatial sharing and recognition in uncontrolled environment. Due to above mentioned low accuracy in uncontrolled environment, face information is not shared between different nodes of a network, so one person can be recognized at different location.

Another issue is insufficient model detection accuracy against large number face database in uncontrolled environment. Due to limited model discriminating power, accuracy, precision and recall, one model usually produce many false positives in large face datasets.

Another issue is the lack of threat prediction mechanism. Due to above mentioned temporal, spatial and limited accuracy, one system and network is not able to provide accurate threat prediction without many false positives or false negatives.

### SUMMARY

In one aspect, systems and methods are disclosed for optimized security monitoring and threat prediction. The system includes cameras specially designed and mounted to consistently capture facial images. The images are then recognized by a machine learning optimized model in private cloud for the consistently captured images. All cameras form a large scale security network whose sensors generate pictorial or video information (such as car, dog, person). Machine learning computer vision software service in private cloud is attached to the security network to generates security information (such as strangers, threatening personal, trust personal); human authenticates security information and benefits from such information. The large scale security network collects and distributes threatening identity information such as face features for machine learning computer vision service. The large scale security network is able to predict imminent threats with high precision and in real time. The network's intelligence grows as usage grows, or as new nodes joins the network.

In one aspect, a system includes a camera; a clip mount coupling the camera to a fixture at a waist, chest, shoulder height or in between to help camera capture images and videos for optimal facial recognition; and a processor running a software coupled to the camera to detect face; The system also includes deep learning computer vision software services running at private cloud through internet to recognize face and identity; the deep learning computer vision software employs minimized image distribution difference between training and deployment; database containing facial information in private cloud for each user; a network with sharing capability to collect or distribute identity to nearby user's database; a software service broadcast recognized threatening person as threatening information to the user himself and nearby user; a mobile app that displays threatening information. The camera capturing consistently aligned images for deep learning; a learning system receiving images from the camera and processing facial images to identify a person, the system minimizing an image distribution difference between training and deployment.

Implementations of the above system and service can include one or more of the following. The camera is waist, chest or shoulder height or in between. The fixture can be a door. The fixture can be a door with a knob on one side and wherein the camera is mounted on an opposite side at a chest or shoulder height. The clip mount slides into a door with a standard thickness such as 1¾ inch, or other doors of 1⅜ inch. The clip mount is swappable. The camera comprises an imaging sensor array, a passive infrared (PIR) sensor, and an image signal processor. A light can be connected to the processor, wherein the processor turns on the light to illuminate a subject. The camera capture images with a standard field of view, such as 45 degrees to achieve high pixel per inch (PPI) for optimal facial recognition. The camera can also include a second wide field of view such as 120 degrees for improved coverage. The system has a predetermined yaw, pitch, row, lighting, dynamic range, noise, motion blur, exposure, sensor type, focal length, lens, with respect to recognition performance turning. The camera has a sensor with a predetermined pixel size with a predetermined frame rate and a predetermined low motion blur. A lens with anti-ghosting is used. An image signal processor can be used to process images at a predetermined frame rate and a predetermined low motion blur. The camera can be controlled by mobile client and generate automated record. A face detection machine learning software can be used within camera system.

A face recognition machine learning/deep learning computer vision software service is used in private cloud over the internet. The computer vision service is load balanced and can process facial images and videos. The load balancer can receive images and videos from home security cameras and distribute across an array of workers in the private cloud. The computer vision software service can have workers which include a video decoder module, a face detection module, a face quality measurement module, a face selection module, and a face feature embedding module. The computer vision software service can detect a face, evaluate the face, generate face features, and compare to a face database to provide information for human to authenticate.

A network can be formed with above cameras to monitor a virtual perimeter of one or multiple buildings, community, region to provide security for residents within. The computer vision software service generates real-time threatening information and safety metrics on a household, a community, and regional level. Metrics are measured as a safety index for one of: a local policy, police monitoring, neighborhood watch program, an advertisement. The camera sensors form a network and network intelligence grows with the number of camera sensors in the network or when usage increases, and when a new threatening identity is flagged, the network distribute it to nearby node, and when a new node is added to network, the new node uses existing flagged threats to warn the new node of known threats in a neighborhood. With any node in network detecting a matched face, it is eligible for broadcasting to neighbors, with or without camera installation, as an alert. The nodes in network is able to record a face when one or more predetermined criteria is matched in a database and a subsequent appearance of the face triggers an alert. The network distributes federal suspect facial information to each user's database for facial recognition and threat prediction. The network also distributes known threatening facial information annotated by user to nearby user account database for threat prediction.

Threat prediction results are delivered to users through internet, such as a message, in app notification, or other protocol, for alert.

Next, a Consumer Camera System Design for Globally Optimized Recognition is discussed. In one aspect, a system and method includes a camera; a clip mount coupling the camera to a fixture at a waist height, chest height, shoulder height or in between on a fixture, facing level to ground to region of interest; clip mounting the camera to the fixture; capturing facial images or videos by above mentioned mounted camera for optimal facial recognition results; can have a processor running a software coupled to the camera to detect face.

Implementations of the above system can include one or more of the following. The fixture has a first side that is moveable and a second side coupled to the facility, and the camera is mounted to the second side. The method includes controlling a light source on the camera to illuminate a face. The method includes measuring environment lighting intensity. The method includes clip on and off at ease. The clip can have adhesive inside to facilitate mounting and prevent slipping in the movement of fixture. The fixture can be a door with a knob on one side and wherein the camera is mounted on an opposite side at a waist, chest, shoulder height or in between. The system includes capturing images with a standard field of view, such as 45 degrees to achieve high pixel per inch (PPI) for optimal facial recognition. The system can also include a second wide field of view such as 120 degrees for improved coverage. The system is has a predetermined yaw, pitch, row, lighting, dynamic range, noise, motion blur, exposure, sensor type, focal length, lens, with respect to recognition performance. The camera has a sensor with a predetermined pixel size with a predetermined frame rate and a predetermined low motion blur. A lens with anti-ghosting is used. An image signal processor can be used to process images at a predetermined frame rate and a predetermined low motion blur.

Next, a Consumer Security Service Network Model is discussed. A collective monitoring network for a collection of separately owned homes or buildings includes a communication channel connecting cameras or sensors from a plurality of homes or buildings in a given region, wherein one or more cameras in each home or building monitor a piece of virtual perimeter of the region and wherein each home or building has separate ownership; a machine learning/deep learning computer vision system receiving images from the camera and processing facial images to identify a person, the system having a minimized imaging distribution difference between training phase and deployment phase through camera placement. The network has a threat computation module based on threat-rank algorithm; a threat distribution module coupled to the threat computation module and the communication channel which broadcasts alerts for the collection of related personals such as residents of the region, based on events and results from threat computation module. A threat rank algorithm computing threats for all homes and buildings of a given region based on any or all facial recognition results from current and past time. A network simulator based on threat rank simulating the collecting and distributing threat information of above mentioned network.

Implementations of the above system can include one or more of the following. The threat computation module collects and generates real-time safety metrics at a household, a community, and regional level. The metrics are measured as a safety index for one or several of: residents, local policy, police monitoring, neighborhood watch program, an advertisement. Network intelligence grows with the number of nodes in the network or when usage increases. Upon detecting a new threat, the network protection module detects and warns a nearby home or building, and when a new home or building is added to network, existing flagged threats are duplicated and used to warn the new home or building of known threats in a neighborhood. Each camera is mounted from waist to shoulder height to capture facial images, the camera having aligned images for deep learning computer vision recognition and wherein the images are aligned with respect to yaw, pitch, row, lighting, dynamic range, noise, motion blur, exposure, sensor type, focal length, lens. The camera clips onto a door for ease of installation. The camera has a regular field of view such as 45 degrees, in order to achieve higher pixel per inch (PPI) and optimal for facial recognition. The camera sensor has a predetermined pixel size with a predetermined frame rate and a predetermined low motion blur. A lens is used to remove ghosting. An image signal processor to process images at a predetermined frame rate and a predetermined low motion blur. A private cloud communicates with the camera that stores and distributes incoming camera video feeds to machine learning/deep learning (ML/DL) computer vision (CV) agents. The private cloud can detect a face, evaluate the face, generate face features, and compare to a face database to provide information for human to authenticate. The nodes in network is able to record a face when one or more predetermined criteria is matched in a database and a subsequent appearance of the face triggers an alert. The network distributes federal suspect facial information to each user's database for facial recognition and threat prediction. The network also distributes known threatening facial information annotated by user to nearby user account database for threat detection. Threat prediction results are delivered to users through internet, such as a message, in app notification, or other protocol, for alert. A method to provide security includes forming a network to collectively protect the homes and buildings; placing one or more camera in each home or building and positioning each camera for capturing consistently aligned images for deep learning computer vision recognition; and sharing information from all residents in given region to identify one or more threats. Network intelligence grows with the number of nodes in the network or when usage increases. Upon detecting a new threat, the threat distribution module detects and warns resident in nearby region, and when a new camera sensor is added to network, existing flagged threats are transferred over and used to warn of known threats in a neighborhood. The quality of service of network in threat computation and threat distribution is realized using a simulator of threat rank model; model parameter can be one of many of camera density, camera location, camera density, a threat signal spatial coefficient, and a temporal degradation coefficient. The simulator can be used for estimating business operational cost and pricing for a predetermined quality of service. The simulator can be used for determining one or more threat metrics for a home, a building, or a region. The simulations can be with or without sensor deployments. The threat rank model and algorithm is expressed as:

$${T}_{i} = α * {T}_{ii} + ( 1 - α ) * ( 1 ( δ ) * \sum \frac{{T}_{ji}}{1 + {dis}_{ji}} )$$

$${T}_{ii} ∈ ( 0 , 1 ) and {T}_{ji} ∈ ( 0 , 1 )$$

where i represents a home or building index, j represents an adjacent home or building index, Tᵢᵢ represents threats from the building's self report, Tⱼᵢ represents threats detected by the adjacent building, and 1(δ) is a piece wise activation function with regard to distance to adjacent home or building. The method includes, for each threat Tᵢᵢ, Tⱼᵢ, determining threat as:

T(t)=β*e^{-τ(t-t0)}*(t−t0)

where τ is a time decay parameter, α is a self-belief parameter, and β is base threat coefficient.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 shows an exemplary camera system for globally optimized face recognition.

FIG. 2 shows in more details the camera of FIG. 1.

FIG. 3A shows a side view of the camera with a clip mount system.

FIG. 3B shows a top view of the camera clip-mounted onto a door.

FIG. 4 shows another clip mount embodiment.

FIG. 5 shows an exemplary wireless camera processing control system.

FIG. 6 shows an exemplary deep neural network for facial recognition.

FIG. 7 shows an exemplary comparison of enhanced facial recognition based on proper camera positioning.

FIG. 8 shows an exemplary comparison of enhanced facial recognition based on proper camera field of view.

FIG. 9 shows how aligned images can be used to improve recognition of facial images.

FIG. 10 shows an exemplary security network, while FIG. 11 shows more details the server for the network of FIG. 10.

FIG. 12A shows an exemplary scenario where suspicious moving objects are detected and shared with other homes in the network.

FIG. 12 B shows an exemplary flow diagram of a process for detecting suspicious moving objects (such as deers that eat plants or package thieves, for example.

FIG. 13A shows in more details the safety sharing network for a neighborhood, while FIG. 13B shows an exemplary safety sharing process.

FIG. 14 shows an exemplary region based face recognition.

FIG. 15 shows an exemplary simulation illustrating the propagation of threats.

FIG. 16 shows an exemplary load balanced private cloud to process facial images.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. The present invention may, however, be embodied in many different forms, and should not be construed as being limited to the embodiments set forth herein. Rather, these embodiments are provided so that this disclosure will be thorough and complete and will fully convey the concept of the invention to those skilled in the art, and the present invention will only be defined by the appended claims.

The present invention will be described with reference to accompanying drawings composed of block diagrams or flow charts to disclose a face recognition system and method according to discussed embodiments thereof.

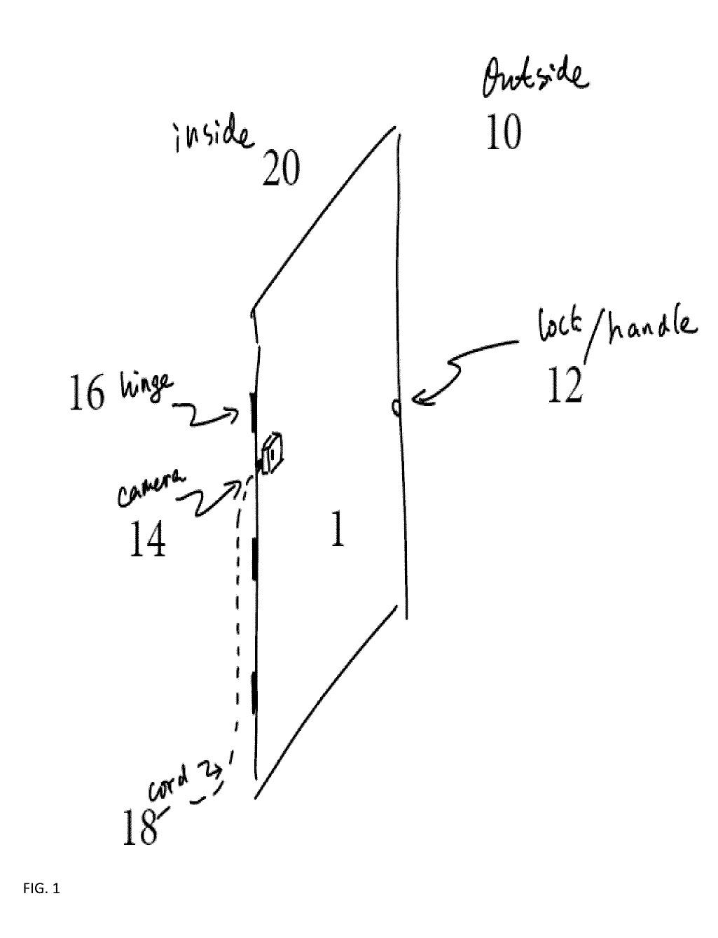

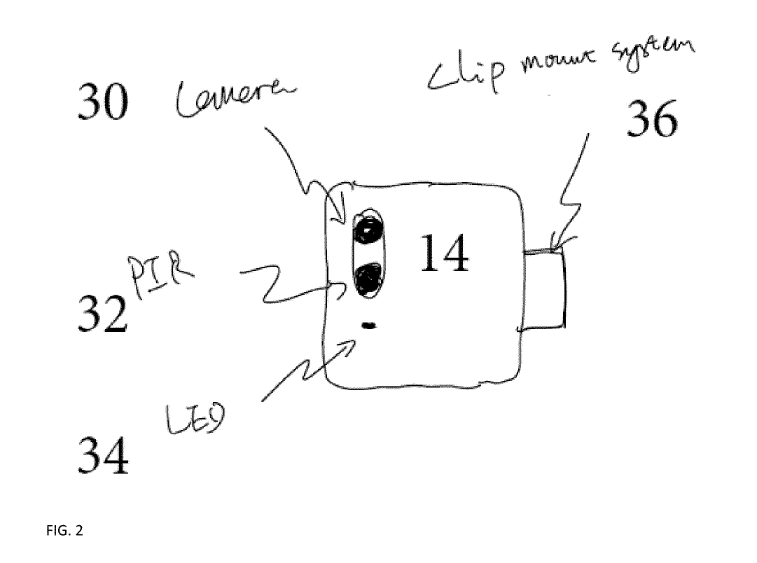

FIG. 1 shows an exemplary camera system for globally optimized face recognition. The system is adapted to be mounted at or near face level of a person of interest. The door 1 has an outside face 10 and an inside face 20. The door 1 has one or more hinges 16 to rotate the door 1. The door 1 has a lock or handle 12 on the outside face 10. A camera 14 is positioned on the outside face 10 to capture visitors and people on the outside. The camera 14 is secured to the door 1 near the hinge 16. To improve image capture, the camera 14 is positioned at a chest or shoulder height on a door 1 on the hinge 16 using a clip mount for ease of installation. The camera 14 can be battery powered, or alternatively a cord 18 can connect the camera 14 to a power source such as the AC line.

FIG. 2 shows in more details the camera of FIG. 1 to achieve improved face imaging quality with proper lighting and camera positioning. The camera can include a professional grade CMOS image sensor 30 with a professional grade ISP (image signal processor) and a normal angle lens, a light such as an LED 34. A PIR sensor 32 can be used to turn the camera on only when people are in front of the camera to reduce processing and energy consumption. The camera is secured to the door with a clip mount 36.

Another sensors that can be used with the camera and PIR can include a force/wave sensor, a microphone, a moisture sensor, or a combination thereof. The force/wave sensor can be at least one of a motion detector, an accelerometer, an acoustic sensor, a tilt sensor, a pressure sensor, a temperature sensor, or the like. The motion detector is configured to detect motion occurring outside of the communications camera security system, for example via disturbance of a standing wave, via electromagnetic and/or acoustic energy, or the like. The accelerator is capable of sensing acceleration, motion, and/or movement of the communications camera security system. The acoustic sensor is capable of sensing acoustic energy, such as a loud noise, for example. The tilt sensor is capable of detecting a tilt of the communications camera security system. The pressure sensor is capable of sensing pressure against the communications camera security system, such as from a shock wave caused by broken glass or the like. The temperature sensor is capable of sensing a measuring temperature, such as inside of the vehicle, room, building, or the like. The moisture sensor is capable of detecting moisture, such as detecting if the camera is submerged in a liquid such as rain, for example.

In an example embodiment, the processor, utilizing information from the sensors, is capable of (via appropriate signal processing algorithms and techniques) to distinguish between a loud noise such a siren for example, and the sound of breaking glass. For example, the communications camera security system can utilize spectral filtering, can compare known signatures of a triggering event with captured sensor information, or the like, to distinguish between a triggering event and a false alarm. In an example embodiment, a library of known types of triggering events (e.g., broken glass, sensor information indicative of a squealing tires, sensor information indicative of a squealing tires, a vehicle crash, sensor information indicative of a person calling for help, sensor information indicative of a car door be forcibly opened, etc,) can be maintained and updated as needed. The known signatures can be compared to received sensor information to determine if a triggering event is occurring.

The processor can apply a list of triggering event signatures preloaded by the service provider or the like. These signatures can be compared with information collected by one or more sensors. The correlated data can be ranked e.g., from 1 to 5 level, for example. Wherein, level 1 is indicative of general monitoring (implies any minor activity sensed, to which the communications camera security system will react). And, level 5 can be indicative of a combination of predetermined levels, such as for example, (a) greater than or equal to xx (e.g., 60) decibel (dB) noise sensed, +greater than or equal to xxx (e.g., 10) lbs of pressure sensed+motion within 10 feet or less detected. The user can specify actions based on the level detected. For example, one signature could be noise level 300 db and pressure 10 lbs to imply a glass broken event (a level 5 event).

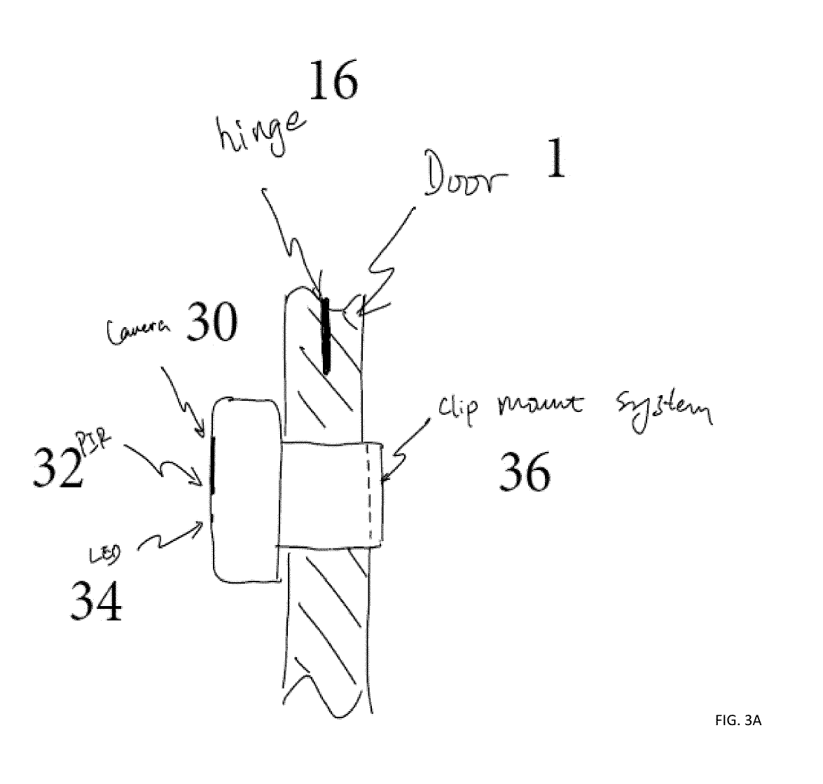

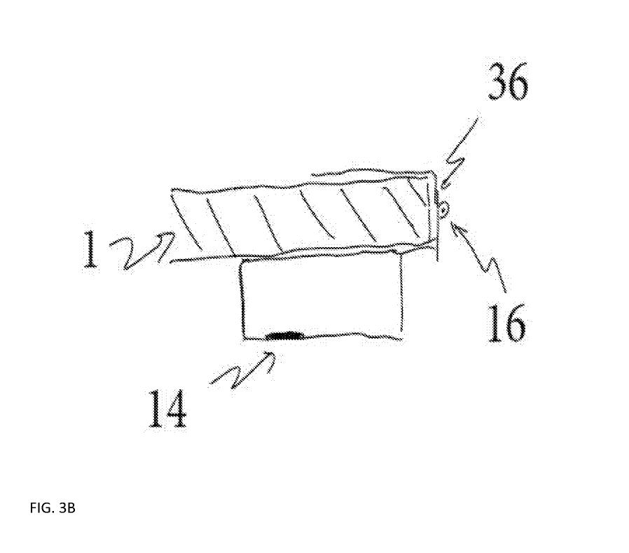

FIG. 3A shows a side view of the camera mounted on the door, while FIG. 3B shows a top view of the camera on the door. The system has a camera 30, a PIR 32, and an LED light 34. The camera 30 is mounted on the door 1, with the hinge 16 positioned near the midline of the door. A clip mount system 36 is used to secure the camera 30 to the door 1 with ease of installation. The system includes a camera; a clip mount coupling the camera to a fixture at a chest height or shoulder height to capture a face at a level point; and a processor coupled to the camera to recognize face. The fixture can be a door or window, for example. The clip mount slides into a door with a thickness of of 1¾ inch, or other doors of 1⅜ inch. The clip mount is swappable.

The camera comprises an imaging sensor array, a passive infrared (PIR) sensor, and an image signal processor. A light can be connected to the processor, wherein the processor turns on the light to illuminate a subject.

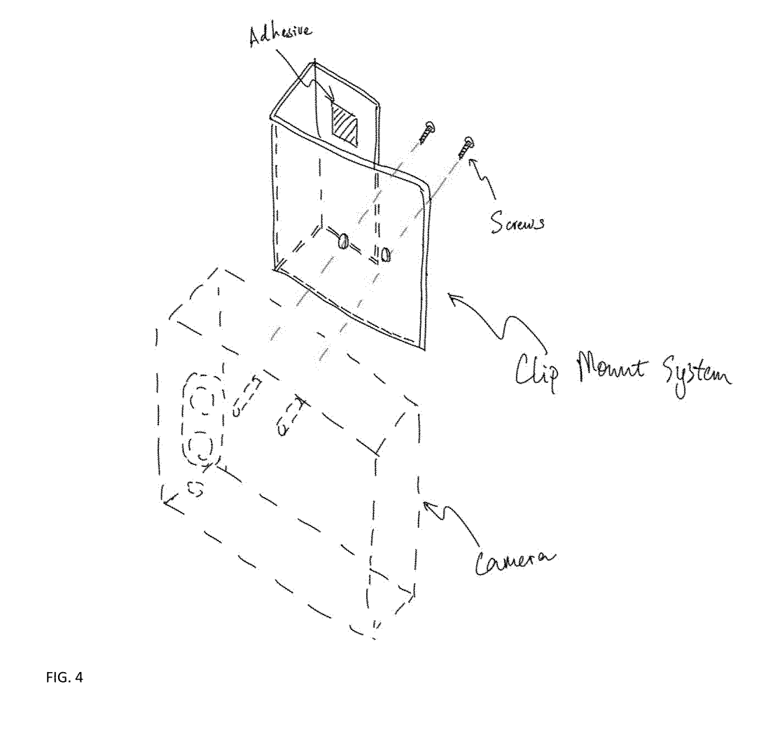

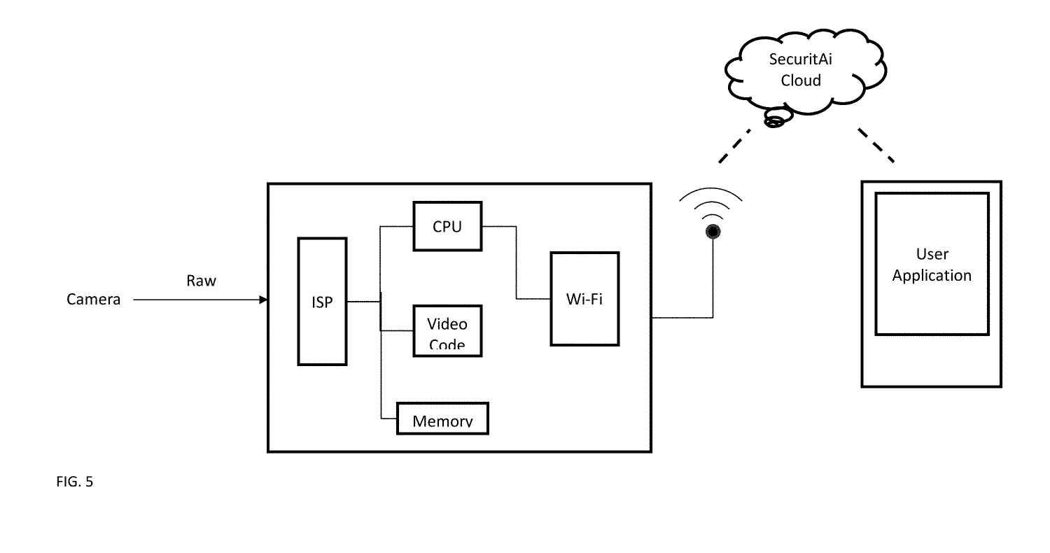

FIG. 4 shows a two piece clip mounted camera system. In this system, the camera module is separate from the clip for ease of battery replacement or mounting, among others. As shown in FIG. 4, the clip has a generally U-shaped, resilient clip body 40, a mounting 42A-42B, and a camera holder 50 Clip body 40 has a first leg, a second leg and a bridge portion extending between the legs forming the substantially U-shaped body 40. The camera holder 50 has two recesses 44A-44B that hooks with the mounting 42A-42B to secure the camera holder 50 to the clip body 40. Although not shown, U-shaped clip body can be made to slide over a door thickness. Interior surface of the legs preferably includes a roughened surface for the purpose of creating better adhesion between mounting clip 40 and door 1 or any mounting surface. Alternatively, second leg interior surface can be provided with grooves (not shown). Second leg is shown as being equal in length to the first leg. Although not illustrated, first leg could be shorter or longer than the second leg depending on the distance necessary for mounting clip 20 to slide under and engage the door in order to create a secure connection.

FIG. 5 shows in more details the camera control electronics. Outputs from the camera sensors are provided to a microprocessor control unit (MCU) via an image sensor interface. The MCU has one or more USB ports by way of the USB host. The MCU stores instructions and data in memory, and the MCU can communicate over WiFi or Bluetooth via the SDIO port, for example. In an example configuration, the memory or a portion of the memory is hardened such that information stored therein can be recovered if the system is exposed to extreme heat, extreme vibration, extreme moisture, corrosive chemicals or gas, or the like. In an example configuration, the information stored in the hardened portion of the memory is encrypted, or otherwise rendered unintelligible without use of an appropriate cryptographic key, password, biometric (voiceprint, fingerprint, retinal image, facial image, or the like). Wherein, use of the appropriate cryptographic key, password, biometric will render the information stored in the hardened portion of the memory intelligible. The memory can store user profile information, user identification information, designated phone numbers to send video and audio information, an identification code (e.g., phone number) of the communications camera security system, video information, audio information, control information, information indicative of signatures (e.g., raw individual sensor information, combination of sensor information, processed sensor information, etc.) of known types of triggering events, information indicative of signatures of known types of false alarms (known not to be a triggering event), or a combination thereof. Depending upon the exact configuration and type of processor, the memory can be volatile (such as some types of RAM), non-volatile (such as ROM, flash memory, etc.). The system can include additional storage (e.g., removable storage and/or non-removable storage) including, tape, flash memory, smart cards, CD-ROM, digital versatile disks (DVD) or other optical storage, magnetic cassettes, magnetic tape, magnetic disk storage or other magnetic storage camera security systems, universal serial bus (USB) compatible memory, or the like.

The system also can contain a UI portion allowing a user to communicate with the communications camera security system 12. The UI portion is capable of rendering any information utilized in conjunction the network 100 as described herein. For example, the UI portion can provide means for entering text, entering a phone number, rendering text, rendering images, rendering multimedia, rendering sound, rendering video, or the like, as described herein. The UI portion can provide the ability to control the system, via, for example, buttons, soft keys, voice actuated controls, a touch screen, movement of the door, visual cues (e.g., moving a hand in front of the camera), or the like. The UI can provide visual information (e.g., via a display), audio information (e.g., via speaker), mechanically (e.g., via a vibrating mechanism), or a combination thereof. In various configurations, the UI can be a display, a touch screen, a keyboard, a speaker, or any combination thereof. The UI can provide means for inputting biometric information, such as, for example, fingerprint information, retinal information, voice information, and/or facial characteristic information. The UI can be utilized to enter an indication of the designated destination (e.g., the phone number, IP address, or the like).

In another example embodiment, the camera comprises a key pad, a display (e.g., an LED display, or the like), a rechargeable battery pack, and a power indicator (e.g., light). The key pad can be an integral or attached part of the communications camera security system or can be a remote key pad. Thus, a wireless key pad and a display can allow a user to key in outbound communication numbers, a secured pass-code, or the like. This pass-code allows the owner to disable the external operating/stand-by/off switch and to soft control the switch mode. When the communications camera security system is switched/set to the stand-by mode, a delay can be initiated (e.g., 20 second delay) before the force/wave sensor starts to operate. When the communications camera security system is equipped with a wireless key pad, the owner can set the mode remotely. When the force/wave sensor detects a trigger, the communications camera security system can automatically dial the preconfigured outbound number and start to transmit the captured video and/or audio information to the designated remote camera security system (e.g., server 130).

In yet another example embodiment, the communications camera security system comprises a two way speaker phone and GPS integration with a video screen. The video screen can optionally comprise a touch screen. A wireless key pad and a GPS video screen can allow a user to key in an outbound communication number, a secured pass-code, or the like. This pass-code allows the user to disable the external operating/stand-by/off switch and to soft control the switch mode. The communications camera security system can receive an SMS type message from a remote camera security system (e.g., a wireless communications camera security system, server 130) which causes the communications camera security system to allow control of functionality of the communications camera security system. The remote camera security system can send SMS-type messages to the communications camera security system to control the camera (angle, focus, light sensitivity, zoom, etc.) and the volume of the speaker phone. The communications camera security system in conjunction with the GPS video capability allows a two way video and audio communication. Utilizing the GPS functionality, the user can be provided, via his/her wireless communications camera security system, location information. Thus, if a car has been stolen, the owner can receive an indication of the location of the car overlaid on a geographical map. When receiving a communication, if the owner is on another call, the call can be preempted, (but not disconnect). Further, a centralized secured database can be utilized to store the video/audio information received from the communications camera security system and can be associated with the communications camera security system identification code and a timestamp. The centralized store video/audio information can be retrieved by subscriber/owner, security service agent, or law enforcement staff on demand.

In one embodiment, the MCU communicates over the WLAN to a server that can communicate over the cloud to the MCU. A face recognition learning machine can process the captured image. The learning machine can be local to the processor, or the face recognition learning machine can be a server coupled to the processor over the Internet.

The camera clip mount system enables fast installation as the camera can be clipped on to the hinge side of door. The camera clip mount preferably has a standard width to accommodate U.S. standard entry door thickness. The clip mount system can be swapped out to other mount easily, using a few screws. The system provides a non-intrusive design, due to the camera designed to install at consumers' front door (entry door).

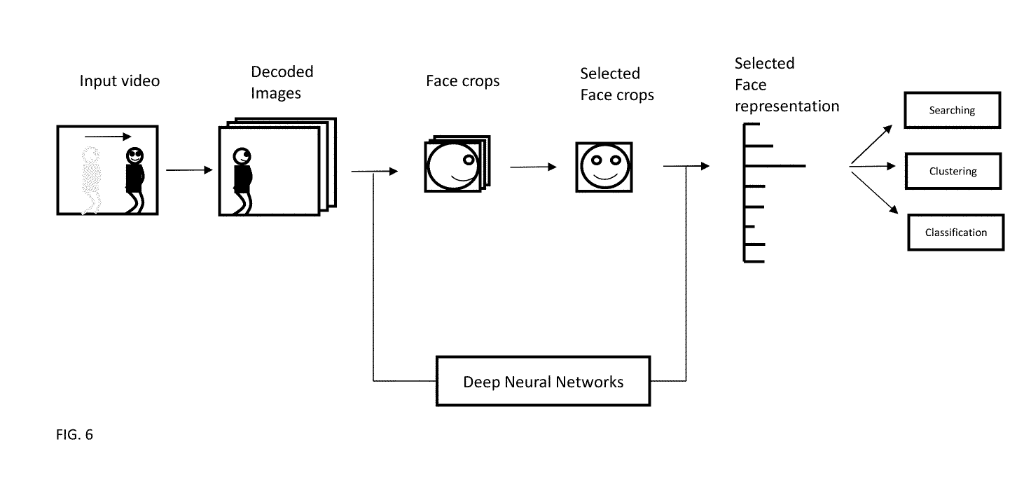

FIG. 6 shows an exemplary facial recognition system. In one embodiment, the system uses OpenFace, an open source face recognizer using deep neural networks. OpenFace is a Python and Torch implementation of face recognition with deep neural networks and is based on the CVPR 2015 paper FaceNet: A Unified Embedding for Face Recognition and Clustering by Florian Schroff, Dmitry Kalenichenko, and James Philbin at Google. Torch allows the network to be executed on a CPU or with CUDA.

Turning now to FIG. 6, an exemplary workflow for a single input image of Sylvestor Stallone is shown. The process detects a bounding box for the face, and fiducials points on the detected face. Next, transform operations can be applied to enhance the face image, and the image is cropped to only the face, and the resulting data is provided to a deep neural network. The resulting representation can be of a 128D unit hypersphere, for example. The result can be used in clustering, similarity detection, or classification. In one embodiment, the process can:
Detect faces with a pre-trained deep learning trained models.
Transform the face for the neural network. This repository uses proprietary real-time pose estimation with OpenCV's affine transformation to try to make the eyes and bottom lip appear in the same location on each image.
Use a deep neural network to represent (or embed) the face on a 128-dimensional unit hypersphere. The embedding is a generic representation for anybody's face. Unlike other face representations, this embedding has the nice property that a larger distance between two face embeddings means that the faces are likely not of the same person. This property makes clustering, similarity detection, and classification tasks easier than other face recognition techniques where the Euclidean distance between features is not meaningful.
Apply clustering or classification techniques to the features to complete the recognition task.

The camera has a narrow field of view (FOV) to improve image quality. Conventional camera systems have a large FOV, such as 120 degrees and above, to cover as wide range as possible. In contrast, the preferred embodiment employs FOVs that are 45 degrees or less to achieve higher PPI (pixel per inch), which translates to larger, clearer face capturing for higher recognition accuracy. The camera leverages a large pixel size CMOS sensor to achieve high frame rate, low motion blur, and robustness to noise. In addition, a high performance Image signal processor (ISP) is used to reduce motion blur and noise and provide a wide dynamic range. The system also leverages lens specifically designed to remove “ghosting” effect during imaging process.

A Machine learning/Deep learning (ML/DL) based computer vision (CV) pipeline is used with the camera. With above mentioned camera, lens, height, the system fine-tunes its deep learning face detection and face recognition pipeline to achieve much high recognition accuracy. With above camera, lens, height, ML, DL, CV pipeline, the infrastructure is organized to achieve high CPU usage and high IO bandwidth usage, in order to reduce per user operational cost.

In one embodiment, the programming instructions comprise instructions to program the system to become configured to train a face recognizer using images of a person's face to generate representation data for the face recognizer characterizing the face in the training images. Face information (in the form of age, skin color, sex in this embodiment) is stored for the representation data defining an age representative of the age of the person at the time of recording the training images used to generate the representation data and therefore representing the details of the person as represented in the representation data. This training is repeated for the faces of different people to generate respective representation data and associated age, skin, and sex data for each person. In this way, the trained face recognizer is operable to process input images using the generated representation data to recognize different faces in the input images. Once the system detects a person as a suspicious person, the system is configured to store confidence data defining how the reliability of the result of face recognition. If any representation data is deemed unlikely to be reliable for face recognition processing, then the user is warned so that new training images can be input and new representation data generated that is likely to produce more accurate face recognition results. Each input image processed by the trained face recognizer is stored in an image database together with data defining the name of each person's face recognized in the image. The database can then be searched in accordance with a person's name to retrieve images of that person of interest.

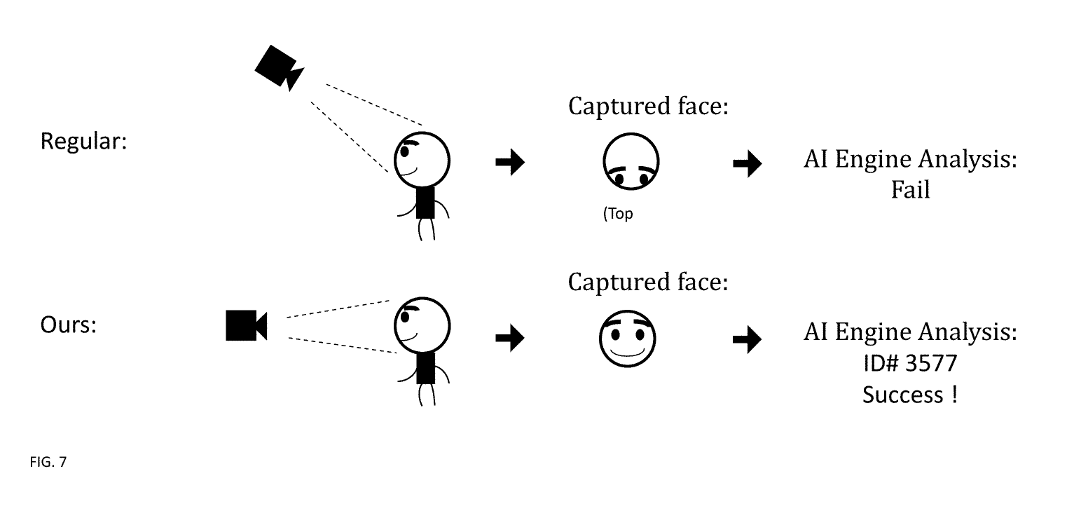

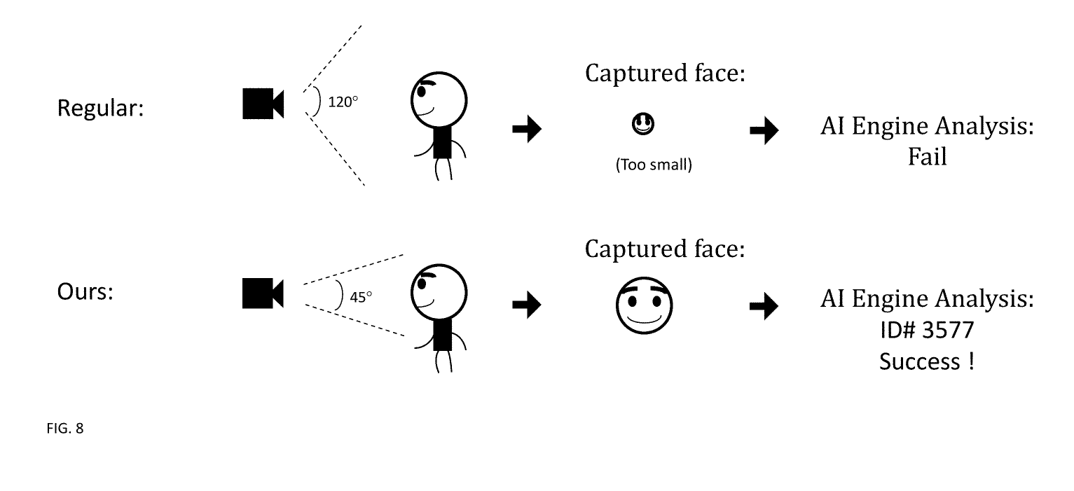

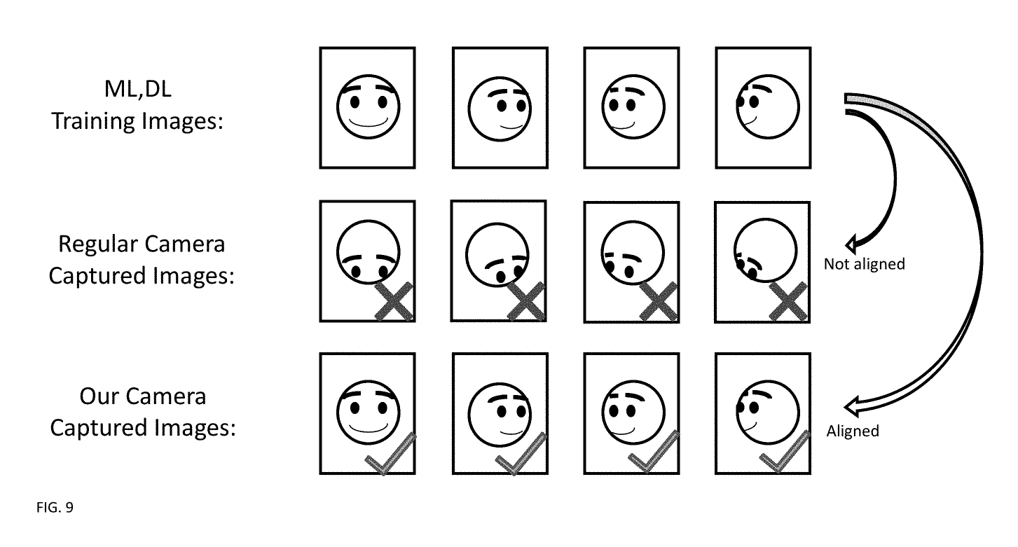

FIG. 6 shows an exemplary comparison of enhanced facial recognition based on proper camera positioning while FIG. 7 shows an exemplary comparison of enhanced facial recognition based on proper camera field of view. FIG. 8 shows how aligned images can be used to improve recognition of facial images. The comparisons in FIGS. 6-8 illustrate advantages of the instant system over conventional surveillance systems. In conventional system, the face from image capture and the face from machine learning training process share different distribution, which causes the system to be sub-optimal in face recognition. Such difference comes from yaw, pitch, row, lighting, dynamic range, noise, motion blur, exposure, sensor type, focal length, lens, etc. To achieve a globally optimized system for recognition, the instant camera and recognition system are optimized for recognition performance. This is done by minimizing the image distribution difference between training and deployment.

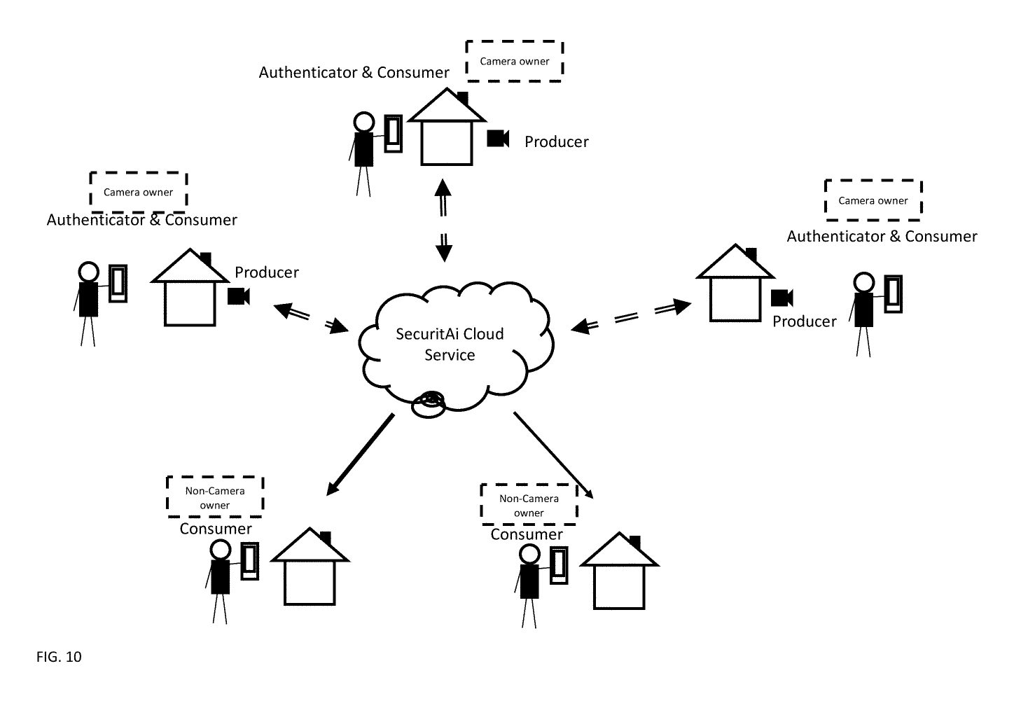

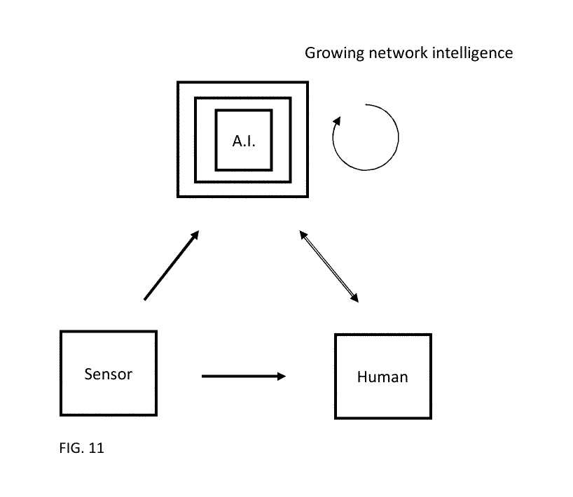

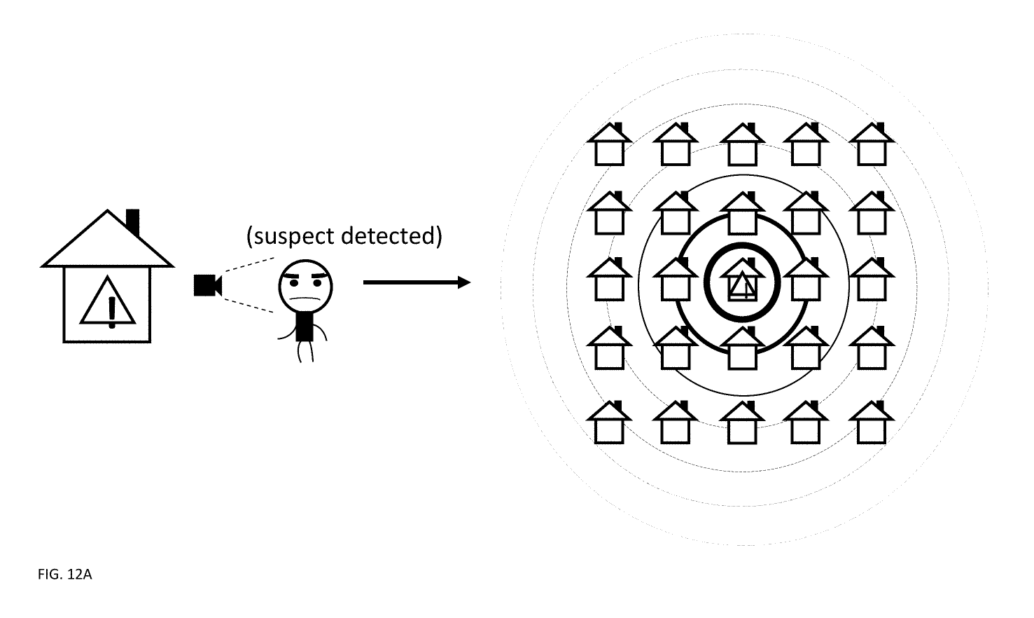

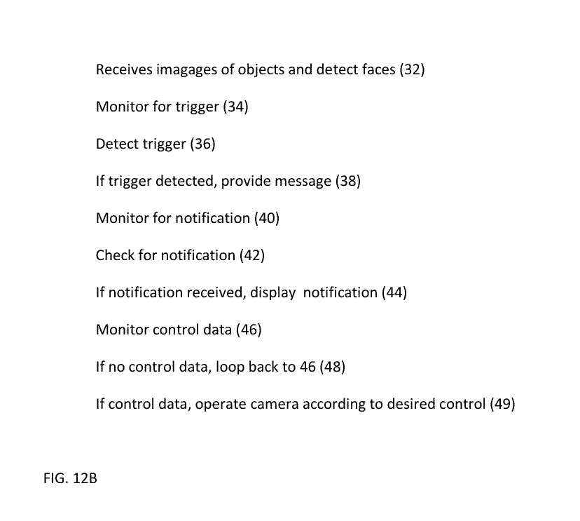

FIG. 10 shows an exemplary security network. The network includes a cloud based security system 100 that communicates with facilities 102-106 with security cameras. Each of the camera facilities has a camera (producer) 108 that serves consumers 110 by authenticating one or more authenticators 112. The system of FIG. 10 can also server facilities without camera 114-118. In these camera-less facilities, the consumer 116 still receives the benefits of warnings on strangers or potentially dangerous conditions broadcasted by other camera facilities in the neighborhood. Thus, the system 100 provides threat analysis, personal alert, threat forecast, and crowd-sourcing and threat sharing capability.

The security network 100 depicted represents any appropriate security network, or combination of network entities, such as a processor, a server, a gateway, etc., or any combination thereof. In an example configuration, the security network comprises a component or various components of a cellular broadcast system wireless network. It is emphasized that the block diagram depicted is exemplary and not intended to imply a specific implementation or configuration. Thus, the security network can be implemented in a single processor or multiple processors (e.g., single server or multiple servers, single gateway or multiple gateways, etc.). Multiple network entities can be distributed or centrally located. Multiple network entities can communicate wirelessly, via hard wire, or a combination thereof.

The memory portion can store any information utilized in conjunction with the network 100. Thus, a communications camera security system can utilize its internal memory/storage capabilities and/or utilize memory/storage capabilities of the security network. For example, the memory portion 36 is capable of storing information related to a message pertaining to occurrence of an event, a location (e.g., of a camera security system, member, etc.), a region proximate to a location, registered cameras within a region, how a camera security system is to be controlled, camera security systems that are registered with the network 100, members that are registered with the network 100, as described herein, or any combination thereof. Depending upon the exact configuration and type of security network, the memory portion can include computer readable storage media that is volatile (such as dynamic RAM), non-volatile (such as ROM), or a combination thereof. The security network can include additional storage, in the form of computer readable storage media (e.g., removable storage and/or non-removable storage) including, but not limited to, RAM, ROM, EEPROM, tape, flash memory, smart cards, CD-ROM, digital versatile disks (DVD) or other optical storage, magnetic cassettes, magnetic tape, magnetic disk storage or other magnetic storage camera security systems, universal serial bus (USB) compatible memory, or any other medium which can be used to store information and which can be accessed by the security network. As described herein, a computer-readable storage medium is an article of manufacture.

The security network also can contain communications connection(s) that allow the security network to communicate with other camera security systems, network entities, or the like. A communications connection(s) can comprise communication media. Communication media typically embody computer readable instructions, data structures, program modules or other data in a modulated data signal such as a carrier wave or other transport mechanism and includes any information delivery media. By way of example, and not limitation, communication media include wired media such as a wired network or direct-wired connection, and wireless media such as acoustic, RF, infrared, and other wireless media. The term computer readable media as used herein includes both storage media and communication media. The security network also can include input camera security system(s) such as keyboard, mouse, pen, voice input camera security system, touch input camera security system, etc. Output camera security system(s) such as a display, speakers, printer, etc. also can be included.

The system provides a consumer security service network model to deliver a large scale security network whose sensors generate security information (such as animals, strangers, and threatening persons, for example); human who authenticates security information and benefits from such information. The large scale security network predicts an imminent threat, such as a potentially threatening person, with high precision. 3) Any one (with or without camera), can benefit from such service in real time. Such network's intelligence grows as usage grows, or as new nodes joins the network.

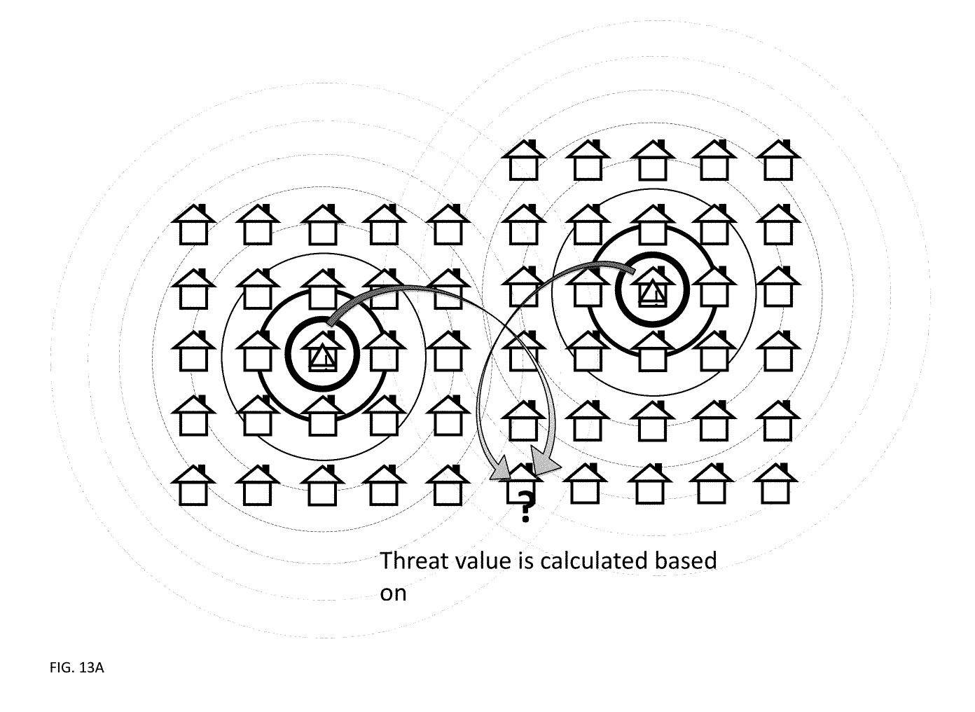

FIG. 11 shows in more details of the system 100. The system includes an artificial intelligence server 130 that applies deep learning to sensors 132 and communicates with users such as human 134. The AI server 130 handles growing network intelligence as more homes add camera with facial recognition in accordance with the preferred embodiments. For example, FIG. 12 illustrates an environment where one home detects a suspicious person, and such suspicious warnings are broadcasted to the neighborhood. Thus, users with or without security cameras can be protected.

FIG. 12A shows an exemplary scenario where suspicious moving objects are detected and shared with other homes in the network. In FIG. 12, a home detects a suspicious person and shares the information with other homes in the neighborhood secured by the system. The home indicates a level of confidence with the detection, and neighboring homes in the system can adjust their cameras to look for the identified suspect.

FIG. 12 B shows an exemplary flow diagram of a process for detecting suspicious moving objects (such as deers that eat plants or package thieves, for example. FIG. 12B is a flow diagram of an example process for implementing the network 100 via a camera security system (e.g., a registered camera such as a security camera, or the like). Pseudo code for the process is as follows:
Receives images of objects and detect faces (32)
Monitor for trigger (34)
Detect trigger (36)
If trigger detected, provide message (38)
Monitor for notification (40)
Check for notification (42)
If notification received, display notification (44)
Monitor control data (46)
If no control data, loop back to 46 (48)
If control data, operate camera according to desired control (49)

The camera security system receives images of people and recognizes faces based on the setup of FIGS. 1-2 at step 32. The camera security system then monitors for a trigger at step 34. The trigger can comprise any appropriate trigger as described herein. If, at step 36, a trigger is not detected, the process proceeds to step 44 to monitor for a trigger. If, at step 36, a trigger is detected, a message is provided at step 38. The camera security system monitors for an indication of a notification, as described herein, at step 40. If, at step 42, it is determined that no indication of a notification has been received by the camera security system, the process proceeds to step 40. If, at step 42, it is determined that indication of a notification has been received, the camera security system renders an indication of the notification (e.g., displays message that a member is in danger, makes sound, displays image of an individual in danger, vibrates, etc.) at step 44. The camera security system monitors for control data, as described herein, at step 46. If, at step 48, it is determined that no control data has been received by the camera security system, the process proceeds to step 46. If, at step 48, it is determined that control data has been received, the camera security system is controlled in accordance with the control data at step 49.

In one embodiment, when an alarm event such as a suspicious person is detected at a member's home, if the server determines that there are no members (except the member sending the help request message) in the proximate region of the event, but has determined that there are registered security camera camera security systems in the proximate region of the event, the server can send information pertaining to the registered cameras to appropriate law enforcement entities to facilitate control and acquisition of information via the registered cameras.

Persons and camera security systems can be registered with the server via any appropriate means, such as a web site, or the like. In an example embodiment, a member can invite his/her friends from other social web sites such as myspace.com, facebook.com, linkin.com, twitter.com, etc., to be a member. In an example embodiment, persons joining the security camera network would be subject to security checks and identity validations prior to approval of membership. In an example embodiment, for privacy protection, an individual, upon becoming a member, could establish an avatar. The avatar would represent the individual to all other members of the network 100.

During registration, or at any time thereafter, a member can select a different opt-in levels, such as, for example, receive or not receive notification of a nearby crime activity, allow or not allow camera security systems to share images with the network and/or a law enforcement agency, allow or not allow a camera security system in danger to use nearby registered cameras to store/forward help messages, etc. A registered camera can comprise any appropriate camera security system capable of monitoring data, recording data, and/or transmitting data. Advantageously, a camera security system can comprise a location determination capability. For example, a camera security system could determine its own geographical location through any type of location determination system including, WiFi positioning, the Global Positioning System (GPS), assisted GPS (A-GPS), time difference of arrival calculations, configured constant location (in the case of non-moving camera security systems), any combination thereof, or any other appropriate means.

When an event is observed or made apparent to a member, the member can trigger his/her camera security system to send the message (e.g., help request) to the server 130, and the server 130 will cause a notification (e.g., member in danger) to be broadcast to all members in the proximate region. The member-in-danger notification will alert members in the region to be more aware. In an example embodiment, a member can accept the notification for a particular event. And, the accepting member can opt to join an assistance mission. The acceptance and indication that the member wants to assist can be provided via any appropriate means. For example, the acceptance/assistance indication can be provided via SMS, voice, video chat, Tweeter, of the like.

In an example embodiment, if the server 130 receives an indication that a home faces danger, the server 130 will provide notification of such in priority order and with tailored messages. For example, friends of the victims could be contacted first with tailored message like “a suspicious person is outside the house at xx location now—current time—”. And all other members in the proximate region could receive a message like “member is in danger at xx location now—current time—”.

In an example embodiment, the server 130 can determine members that may be potential witness to an event. A list of such members can be generated and provided to authorized agencies, such as law enforcement, courts, etc. If a member prefers to remain anonymous, a message can be sent to the member requesting the member to come forward as a witness.

An event does not necessarily have to comprise a crime. The event can comprise an appropriate event such as in indication to the network 100 a member would like someone or something to be monitored, an indication that a person of thing has been lost, or the like. For example, a member can provide a message to the network 100 that she is going hiking, where she will be hiking, and when she should return. The network 100 can monitor the region where the member will be hiking, and if the member does not return around the predicted time, alert other members to search for the hiking member. Information obtained while monitoring the hiking region can be provide to member to help find the hiking member. As another example, a member can provide a message to the network 100 that he has lost his cell phone and his best guess as to where he was when he lost it an when he lost it. The network 100 can provide a request to the appropriate service provider to help locate the cell phone and temporarily block selected functionality of the cell phone (e.g., block outgoing calls/messages). The service provider could call the cell phone, and members in the area where the phone is thought to be could be requested to listen for the ringing cell phone. In an example embodiment, a special ring tone could be used when ringing the phone, for easy identification by members.

In an example configuration, the system can determine its own geographical location through any type of location determination system including, for example, the Global Positioning System (GPS), assisted GPS (A-GPS), time difference of arrival calculations, configured constant location (in the case of non-moving camera security systems), any combination thereof, or any other appropriate means. In various configurations, the input/output portion 18 can receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion comprises a WIFI finder, a two way GPS chipset or equivalent, or the like.

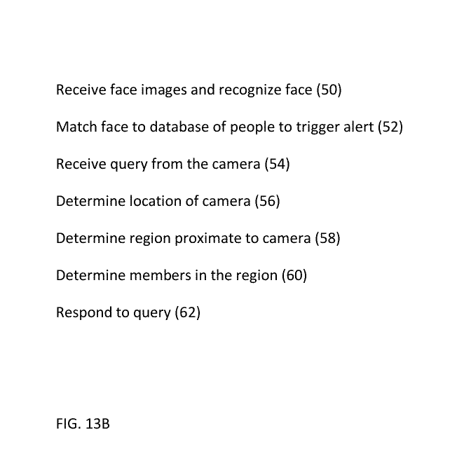

FIG. 13A shows in more details the safety sharing network for a neighborhood. In this embodiment, a home broadcasts a message to neighboring home security cameras to search for unsafe suspects in the neighborhood and to request notification to help keep the neighborhood safe, for example.

FIG. 13B is a flow diagram of an example process for implementing the network 100 via a security network:
Receive face images and recognize face (50)
Match face to database of people to trigger alert (52)
Receive query from the camera (54)
Determine location of camera (56)
Determine region proximate to camera (58)
Determine members in the region (60)
Respond to query (62)

The camera security system receives images of people and recognizes faces based on the setup of FIGS. 1-2 at step 50-52. A message is received at step 54. As described herein, the message can comprise an indication of an event, such as, for example, an occurrence of a crime, a article is lost, a person is lost, a person is in danger, a person wants to be monitored, or the like. The message can include location information pertaining to the location of the source of the message. The message can contain any other appropriate information, such as, for example, a picture, an image, video, text, of the like. In an example embodiment, the security network confirms that the message was sent by a registered member of the network 100 or was sent by a registered camera of the network 100. Confirmation can be conducted in any appropriate manner. For example, a list of registered members can be compared to the subscriber associated with the source of the message, and/or a list of registered cameras can be compared with the camera security system associated with the source of the message. If a match is found, the member/camera security system can be confirmed as being registered with the network 100.

A location is determined at step 56. In an example embodiment, the location is the location of the source of the message. As described herein, the location can be determined based on the location provided with the message and/or any other appropriate means, such as, for example, the Global Positioning System (GPS), assisted GPS (A-GPS), time difference of arrival calculations, configured constant location (in the case of non-moving camera security systems), or any combination thereof. In an example embodiment, the message can include location information pertaining to other than a location of the source of the message. For example, the message can contain location information of another person (e.g., location of teen about to jump off bridge). A region proximate to the determined location is determined at step 58. As described herein, the proximate region can be any appropriate region proximate, such as, for example, the region including a building in with the location is located, a parking lot near the location, a field near the location, a highway/road near the location, or the like. In an example embodiment, the region may not be stationary. The region can be continuously updated as the nature of the event changes. For example, if the event involves a robbery, as the perpetrators are leaving the scene of the crime, the region will be updated to be proximate to the location of the perpetrators. Information pertaining to the location of the perpetrators can be provided by registered cameras. Thus, the region can be stationary or dynamically changing.

At step 60, members in the region are determined. In an example embodiment, the security network determines all registered members, determines the location of registered members, and determines if any members are located within the region. At step 62, registered cameras in the region are determined. In an example embodiment, the security network determines all registered cameras, determines the location of registered cameras, and determines if any registered cameras are located within the region. At step 64, the security network determines which members are to be notified. In an example embodiment, all members within the region are selected to be notified. In another example embodiment, members that may not be in the region and are predicted to be within the region are selected to be notified. For example, a member may be moving toward the region, and accordingly, the security network could select the member to be notified. In an example embodiment, the region may be dynamically changing as described above, and thus members predicted to be within the dynamically changing region can be selected to be notified. At step 66, the security network determines which registered cameras are to be controlled and/or monitored. In an example embodiment, all members within the region are selected to be notified. In another example embodiment, registered cameras may not be in the region but are predicted to be within the region are selected to be controlled/monitored. For example, a registered camera (e.g., a camera on a moving vehicle) may be moving toward the region, and accordingly, the security network could select the registered camera to be controlled/monitored. In an example embodiment, the region may be dynamically changing as described above, and thus registered cameras predicted to be within the dynamically changing region can be selected to be controlled/monitored.

Appropriate notification, as described herein, is provided to the selected members at step 68. And appropriate control/monitor data, as described herein, is sent to selected registered cameras at step 70. Control data can instruct a registered camera to monitor (audio, video, and/or still images) a situation, to store obtained (via monitoring) information, transmit obtained (via monitoring) information, make a noise or flash of light (e.g., strobe, siren, etc.) to ward off an attacker or the like, to adjust a viewing angle of a camera, adjust an audio level of an amplifier, or the like, or any combination thereof. Appropriate notification is sent to appropriate authorities, as described herein, at step 74. Providing notification to authorities is optional.

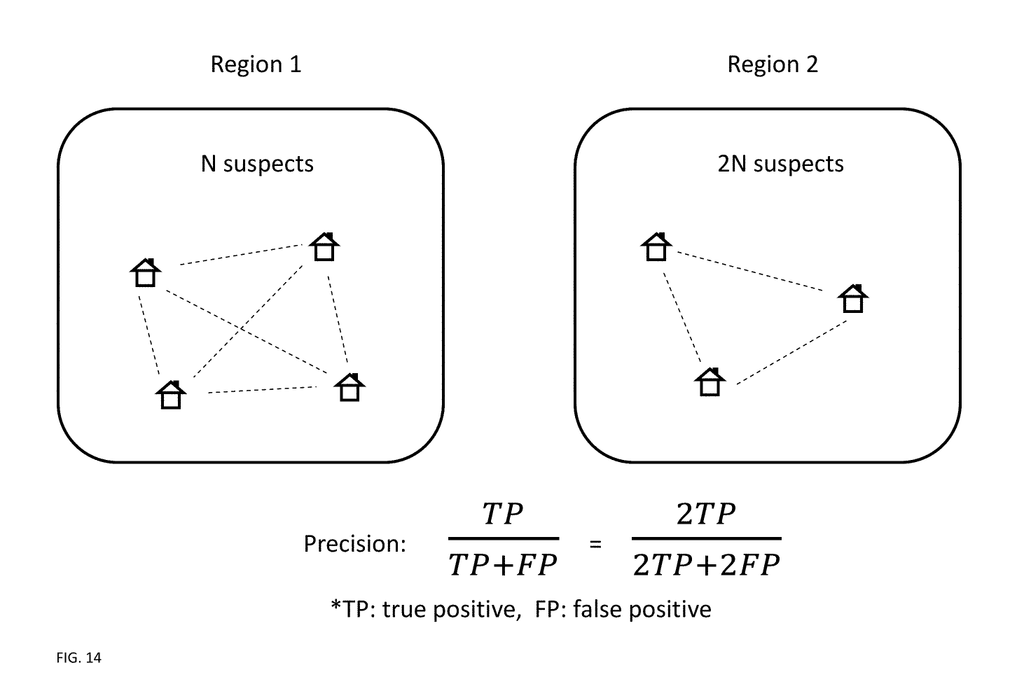

FIG. 14 shows an exemplary region based face recognition. Traditional camera surveillance system fail to leverage region based information to predict threats due to accuracy limitation from machine learning model, training data, imaging process, exposure, motion blur, etc., large scale face recognition is difficult to achieve high precision and high recall. In one implementation, the system applies region based face recognition, which leverages locality as prior knowledge to improve precision and recall.

Compare two systems, the 1st with N suspects, the 2nd with 2*N suspects, and a same machine learning model with exactly the same accuracy, precision. (Precision defined as the ratio of (number of true positives)/(number true positives+number false positives)). The absolute number of false positive (false alarm) for the 1st system is half as the 2nd system. From user experience, precision out-weights the recall (Recall defined as the ratio of (number true positives)/(number true positives+number false negatives). The lower the false positive, the better user experience is, because in consumer market, users are overloaded by information everyday. We use geolocation as prior knowledge to break one large region equally into two smaller regions (can be chained even further). As a result, with the same accuracy model, the precision is improved, so is user experience.

To achieve high recall, the network system leverages both temporal and spatial probability. Temporal probability means that, in a network, if suspect appear at another time at the same node, the suspect can be recognized; spatial probability means that, in a network, if a suspect appears at another node, the suspect can be recognized. As a result, the system is able to achieve high precision without losing recall.

The system leverages federal suspects information and high precision face detection to achieve high precision and recall threat detection. Precision is improved using prior knowledge of user's and suspect's geolocation Given <suspect face photo/feature, suspect last geolocation> pair and machine learning/deep learning model, the system's camera sensor and network service is able to detect suspect if s/he is picked up by camera sensor in network. Such threat information aims at high precision rather than high recall, for face recognition, to reduce false positives. Such threat information can be shared regionally, to warn and protect residents of the area. The user is able to tag a suspect, and another camera sensor in network is able to utilize such information to generate threat alert and broadcast back to network. For false positives, the network can provide a service for verification and removal the suspect from the database.

To test the system, a Consumer Security Service Network Model Simulator is used. Traditional consumer surveillance system(s) are single home based, without spatial association and maybe little temporal association. In one embodiment, a network model is generated for simulating consumer security service that represents model, simulation and derived functionalities. In one implementation, the simulator runs the following pseudo-code:

```
      /* The system and network operates in a state machine fashion,
      where the current states turns into past states.
      Threats are calculated using both current and past state of threat. */
      while(system is running):
        // get current time
        current_time = current_time( )
        // Save current events for later use
        past_events = current_events
        // get camera sensor detection events from network
        current_events = receive_report( )
        // calculate threat based on all reported events in nearby homes, with their past and current
events, current time, distance, and decay
        threat = calculate_threat(past_events, current_evetns)
        // update the 2D house overlayed with threat values
        update_graph(threat)
        // every one hour, update reports and recalculate threat status
        sleep(1 hour)
```

In one embodiment, the threat modeling and simulation is based on a Threat-Rank process, which relies on a Threat-Rank Function

$${T}_{i} = α * {T}_{ii} + ( 1 - α ) * ( 1 ( δ ) * \sum \frac{{T}_{ji}}{1 + {dis}_{ji}} )$$

$${T}_{ii} ∈ ( 0 , 1 ) and {T}_{ji} ∈ ( 0 , 1 )$$

where i represents house id of interest, j represents house id nearby, Tᵢᵢ represents threats from self report (where a sensor detect person of interest, such as suspect), Tⱼᵢ means threat detected by others' sensor.
For each threat above Tᵢᵢ, Tⱼᵢ, the following representation is used to calculate its threat:

T(t)=β*e^{-τ(t-t0)}*(t−t0)
As can be seen, there's a temporal decay process after threat occurrence. Parameters of system include:
Tau τ Time decay parameter, which describes how fast a threat decays over time. The higher of τ, the faster the threat decays.
Alpha α Self-belief parameter. Alpha decides the degree of the threat picked up by it self versus the propagated threat in a given range.
Beta β β is base threat coefficient, usually β=1.
Clip distance function 1(δ) Piece wise function for distance regulation. For distance less than δ, output is 1, otherwise 0. It decides the houses considered in threat calculation based on radius circle. Only the reports inside the circle will contribute to the threat calculation of house of interest.

The system generates a model or a mathematical representation of network, known as “security-rank”, which is numerical solvable and bounded-input-bounded-output, to calculate the security of given home address and region. Leveraging the model representation, the system can simulate a quality of service, by tuning with model parameter, such as camera/sensor density, threat signal spatial and temporal degradation coefficients. Next, leveraging the representation, the system can simulate dynamic behavior of threats in the network. Further, in leveraging above representation, the system can estimate business operational cost and pricing strategies. The system can also calculate threat metrics for home, region, with and without actual sensor deployment.

FIG. 14 shows an exemplary simulation illustrating the propagation of threats. This simulation sample shows:

1. In reality threats are dynamic, it propagates through space and time

2. Home with and even without our camera sensor has one or more threat/safety metrics

3. The darker the color is, the more the danger

4. Area/home accumulated with more threats gets higher threat scores.

5. Given an area with low sensor coverage, the service fee is likely to be low due to it's contribution of security signal to nearby residents

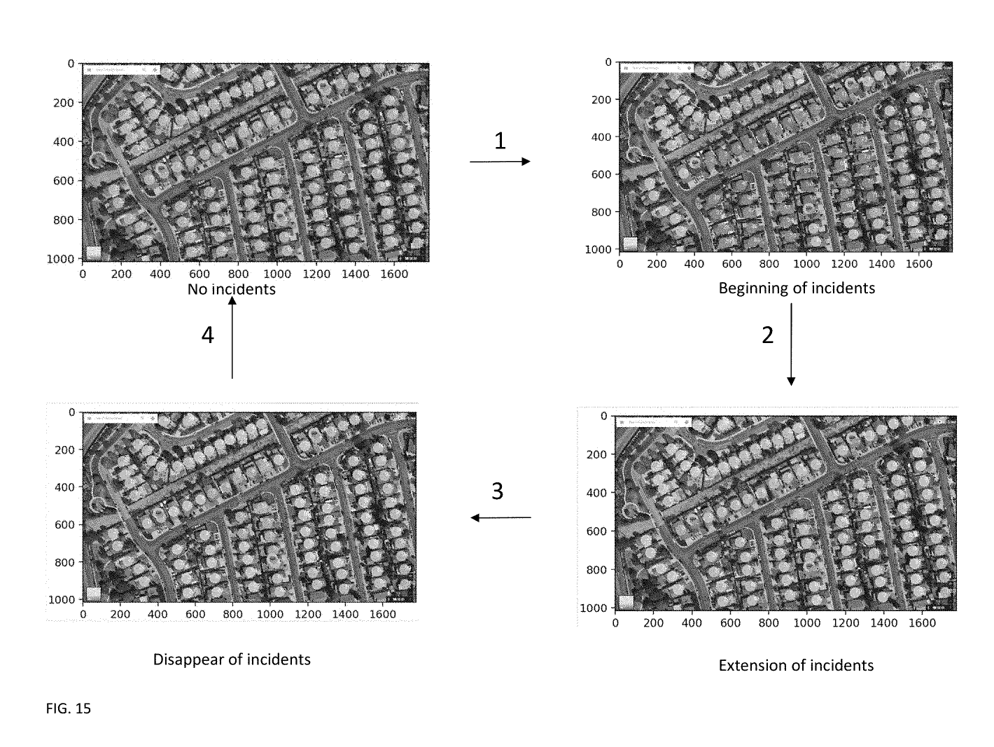

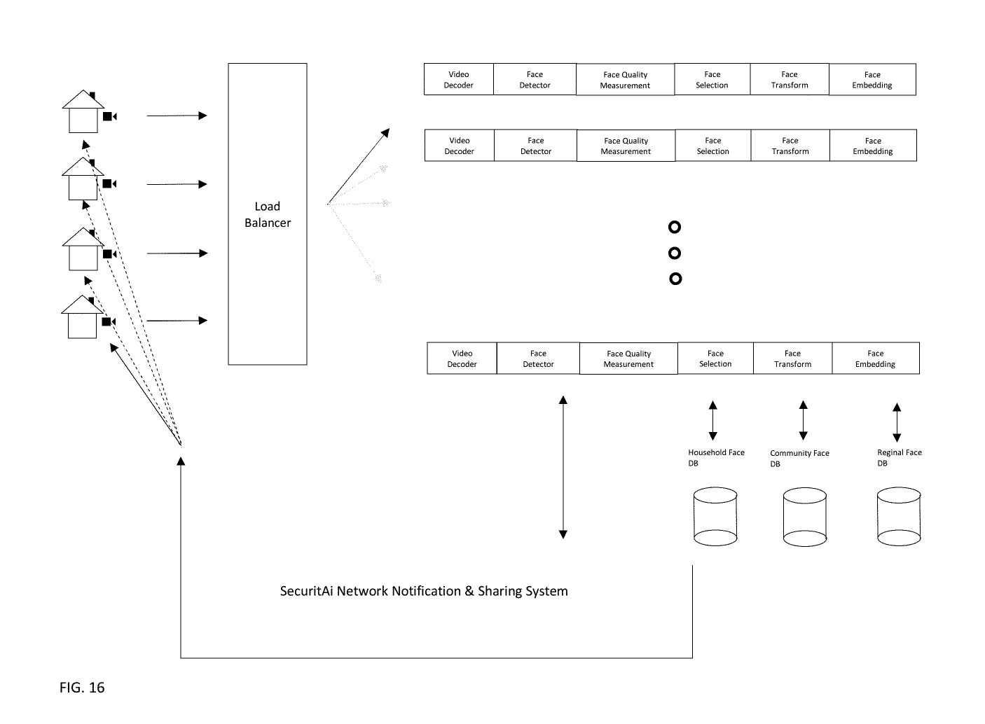

FIG. 16 shows an exemplary load balanced private cloud to process facial images. The system of FIG. 15 receive videos from home security cameras and the data is provided to a load balancer 210. The load is then distributed across an array of workers in a private cloud. The load balancer 210 acts as a reverse proxy and distributes network or application traffic across a number of servers. Load balancers are used to increase capacity (concurrent users) and reliability of applications. They improve the overall performance of applications by decreasing the burden on servers associated with managing and maintaining application and network sessions, as well as by performing application-specific tasks. Load balancers are generally grouped into two categories: Layer 4 and Layer 7. Layer 4 load balancers act upon data found in network and transport layer protocols (IP, TCP, FTP, UDP). Layer 7 load balancers distribute requests based upon data found in application layer protocols such as HTTP. Requests are received by both types of load balancers and they are distributed to a particular server based on a configured algorithm such as Round robin, Least connections, and Least response time, among others. Layer 7 load balancers can further distribute requests based on application specific data such as HTTP headers, cookies, or data within the application message itself, such as the value of a specific parameter. Load balancers ensure reliability and availability by monitoring the “health” of applications and only sending requests to servers and applications that can respond in a timely manner.

The workers include a video decoder 220, a face detection module 222, face quality measurement module 224, a face selection module 226, and a face feature embedding module 228. Each worker thread communicates with a family face database 230, a community face database, and a public face database.

The databases 230 allow the system to be trained for situation specific or context specific facial recognition to improve accuracy. Thus, the system would run the recognizer from the family faces DB first, and if it does not find suitable matches, the system searches the community face database. If all else fails, the system searches the public face database to identify a particular person, for example.

In one embodiment, each of 222-228 modules is service and event driven. Exemplary pseudo-code executed by the modules when each receives a job is as follows:

```
      ----------------------------------------------------------------------------
      face detection module 222:
      ----------------------------------------------------------------------------
      OnFaceDetectionJobReceivedThreadFunction( )
        for idx in (start_idx, end_idx): // start_idx and end_idx are calculated in video decoding
module
        face_crop[idx], face_bounding_box[idx], face_confidence[idx] =
DetectFace(image[idx])
        save(face_crop[idx], face_confidence[idx]) // save to file system
        return face_crop[ ]
      ----------------------------------------------------------------------------
      face quality measurement module 224:
      ----------------------------------------------------------------------------
      OnFaceQualityJobReceivedThreadFunction( )
        for idx in (start_idx, end_idx):
        face_size, face_angle, face_sharpness = FaceQuality(face_crop[idx], alpha, beta,
gamma) // where alpha, beta and gamma are hyper parameters that is adjust by another
developer tool and final customer
        save(face_score[idx]) // save to file system
        return face_score[ ]
      ----------------------------------------------------------------------------
      OnFaceSelectionJobReceivedThreadFunction( )
      ----------------------------------------------------------------------------
        face selection module 226:
        for idx in (0, N):
        selected_face[idx] = FaceSelect(face_crop[ ], face_score[ ]) // select top N face crops
based on above mentioned face quality metrics
        save(selected_face[idx]) // save to file system
      return selected_face[ ]
      ----------------------------------------------------------------------------
      OnFaceEmbeddingJobReceivedThreadFunction( )
      ----------------------------------------------------------------------------
        face embedding module 228:
        for idx in (0, N):
        face_embedding[idx] = FaceEmbedding(selected_face[idx ])
        return face_embedding[ ]
```

The system can be applied to security applications, such as seeking to identify a person whose face is captured by a camera. Other applications include searching a set of photographs to automatically locate images (still or video) that include the face of a particular person. Further, the invention could be used to automatically organise images (still or videos) into groups where each group is defined by the presence of a particular person or persons face in the captured image.

At this time, it will be understood that each block of the flowchart illustrations and combinations of blocks in the flowchart illustrations can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks.

These computer program instructions may also be stored in a computer that can direct a computer or other programmable data processing apparatus to function in a particular manner, such that the instructions stored in the disclosure of the present invention produce an article of manufacture including instruction means that implement the function specified in the flowchart block or blocks.

The computer program instructions may also be loaded onto a computer or other programmable data processing apparatus to cause a series of operations to be performed on the computer or other programmable data processing apparatus to produce a computer implemented process such that the instructions that are executed on the computer or other programmable data processing apparatus provide operations which implement the functions specified in the flowchart block or blocks.

Each block of the flowchart illustrations may represent a module, segment, or portion of code, which comprises one or more executable instructions which implement the specified logical function(s). It should also be noted that in some alternative implementations, the functions noted in the blocks may be in fact be executed substantially concurrently, or the blocks may be executed in reverse order, depending upon the functionality involved.

According to an embodiment of the present invention, face verification is conducted only when it is first used within a time limit for face identification, and face identification is thereafter conducted until the time limit expires, thereby creating an efficient system. In addition, the present invention is effective in enhancing the security level of face identification and face recognition.

Although a few embodiments of the present invention have been shown and described, it would be appreciated by those skilled in the art that changes may be made in these embodiments without departing from the principles and spirit of the invention, the scope of which is defined in the claims and their equivalents.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for clip camera mounts as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A surveillance system, comprising:
a camera mounted near chest height to capture facial images, the camera capturing consistently aligned images for deep learning;
a learning system receiving images from the camera and processing facial images to identify a person, the system minimizing an image distribution difference between training and deployment.

2. The system of claim 1, wherein the images are aligned with respect to yaw, pitch, row, lighting, dynamic range, noise, motion blur, exposure, sensor type, focal length, lens.

3. The system of claim 1, wherein the camera clips onto a door for ease of installation.

4. The system of claim 1, wherein the camera has a 45 degrees field of view (FOV), in order to achieve higher pixel per inch (PPI).

5. The system of claim 1, wherein the camera comprises a sensor with a predetermined pixel size with a predetermined frame rate and a predetermined low motion blur.

6. The system of claim 1, comprising a lens to remove ghosting.

7. The system of claim 1, comprising an image signal processor to process images at a predetermined frame rate and a predetermined low motion blur.

8. The system of claim 1, comprising a private cloud coupled to the camera that stores and distributes incoming camera motion video feeds to machine learning/deep learning (ML/DL) computer vision (CV) agents.

9. The system of claim 1, comprising a private cloud to detect a face, evaluate the face, generate face features, and compare to a face database to provide information for human to authenticate.

10. The system of claim 9, wherein the private cloud detects a spatial association and a matched face is eligible for broadcasting to neighbors as an alert.

11. The system of claim 9, wherein the private cloud detects a temporal association where a face matching one or more predetermined criteria is recorded in a database and a subsequent appearance of the face triggers an alert.

12. The system of claim 1, wherein the camera is easy to install and controlled using a mobile application with automated report and record generation and sharing of alerts for neighbors and police.

13. The system of claim 1, comprising a network with sensors monitoring a virtual perimeter of each building to provide security for residents of all buildings in the network.

14. The system of claim 1, wherein the learning system generates real-time safety metrics at a household, a community, and regional level.

15. The system of claim 14, wherein the metrics are measured as a safety index for one of: a local policy, police monitoring, neighborhood watch program, an advertisement.

16. The system of claim 1, wherein the sensors form a network and network intelligence grows with the number of nodes in the network or when usage increases, and when a new threat is flagged, the network detects and warns a nearby node, and when a new node is added to network, the new node uses existing flagged threats to warn the new node of known threats in a neighborhood.
